(19) United States
(12) Patent Application Publication
(10) Pub. No.: US 2019/0122697 A1
(43) Pub. Date: Apr. 25, 2019

(54) METHOD OF PRODUCING ALUMINUM ALLOY SUBSTRATE FOR MAGNETIC RECORDING MEDIUM

(71) Applicant: SHOWA DENKO K.K., Tokyo (JP)

(72) Inventors: Koji YUKIMATSU, Chiba-shi (JP); Tomoya KOBAYASHI, Oyama-shi (JP)

(73) Assignee: SHOWA DENKO K.K., Tokyo (JP)

(21) Appl. No.: 16/162,608

(22) Filed: Oct. 17, 2018

(30) Foreign Application Priority Data
Oct. 20, 2017 (JP) 2017-203300

(51) Int. Cl. G11B 5/73; C22C 21/00; G11B 5/84; G11B 5/82

(52) U.S. Cl. CPC G11B 5/7315; C22C 21/00; G11B 5/65; G11B 5/82; G11B 5/8404

(57) ABSTRACT

A method of producing an aluminum alloy substrate for a magnetic recording medium, which uses a grinding apparatus (10) for grinding both principal planes of the aluminum alloy substrate by a grinding pad (14) by arranging the aluminum alloy substrate in an opening (13a) provided in a carrier plate (13), and relatively moving the carrier plate (13) in a plane with respect to an upper platen (11) and a lower platen (12), while supplying a grinding fluid onto a surface of the aluminum alloy substrate, wherein the grinding pad (14) has a structure in which a plurality of tile-shaped convex portions having a flat top portion are provided side by side and diamond abrasive grains are included in the convex portion and fixed in the convex portion by a binder, an average particle diameter of the diamond abrasive grains is from 2 to 15 μm, and a content of diamond abrasive grains in the convex portions is from 5 to 50% by volume.

### BACKGROUND OF THE INVENTION

### Field of the Invention

The present invention relates to a method of producing an aluminum alloy substrate for a magnetic recording medium.

Priority is claimed on Japanese Patent Application No. 2017-203300, filed Oct. 20, 2017, the content of which is incorporated herein by reference.

### Description of the Related Art

In recent years, due to the growing demand for recording media, the production of magnetic recording media used for hard disk drives (HDD) is becoming active. As a magnetic recording medium used for an HDD, a doughnut disk-shaped aluminum alloy substrate and glass substrate are widely used. Of these, the aluminum alloy substrate is advantageous from the viewpoints of excellent workability and low cost. On the other hand, the glass substrate is advantageous in view of excellent strength.

Conventionally, in a manufacturing process of a magnetic recording medium, polishing and grinding of a substrate for a magnetic recording medium are performed. As a polishing or grinding process of a substrate for a magnetic recording medium, there is a method in which a carrier plate is sandwiched between a pair of upper and lower platens that are opposed to each other while holding a substrate in a holding hole of the carrier plate, and both principal planes of the substrate are polished or ground by relatively moving these platens and the carrier plate in a plane.

For example, the following Patent Document 1 describes a technique in which a workpiece is positioned in a workpiece holding hole of a carrier for a polishing machine, and the upper and lower surfaces of the workpiece are polished by abrasive grains in an abrasive supplied between the upper platens and the lower platens that are relatively moved with respect to these surfaces.

Incidentally, due to the development of the Internet network and expansion of utilization of big data in recent years, the amount of data accumulated in the data center has also been continued to increase. In addition, due to the problem in terms of space of the data center, there is a necessity to increase the storage capacity per unit volume of the data center.

Accordingly, in order to increase the storage capacity per standardized hard disk drive, in addition to increasing the storage capacity per magnetic recording medium, attempts have been made to increase the number of magnetic recording media to be accommodated in the drive case. Further, in order to increase the number of magnetic recording media to be accommodated inside the drive case, attempts have been made to thin the substrates used for the magnetic recording media.

However, when the substrate is made thin, since the aluminum alloy substrate has lower Young's modulus than the glass substrate, fluttering tends to occur. The term “fluttering” refers to fluttering of a magnetic recording medium which occurs when the magnetic recording medium is rotated at a high speed. When the level of fluttering increases, a stable reading operation becomes difficult in the HDD.

In the following Patent Document 2, as an aluminum alloy substrate having a high Young's modulus, a substrate for a magnetic recording medium has been disclosed, which contains Mg in a range of 0.2 to 6% by mass, Si in a range of 3 to 17% by mass, Zn in a range of 0.05 to 2% by mass and Sr in a range of 0.001 to 1% by mass.

The above-described aluminum alloy substrate for a magnetic recording medium is generally produced by the following steps. First, an aluminum alloy ingot is rolled to obtain an aluminum alloy sheet material having a thickness of about 2 mm or less. The obtained aluminum alloy sheet material is punched into a doughnut disk shape to obtain an aluminum alloy substrate having a desired size.

Next, chamfering of the inner and outer diameters and turning of both principal planes (surfaces ultimately becoming the recording surfaces of the magnetic recording medium) are performed on the punched aluminum alloy substrate. Thereafter, in order to reduce the surface roughness and waviness of the aluminum alloy substrate after the turning process, both principal planes of the aluminum alloy substrate are subjected to a grinding process with a grindstone.

Next, for the purpose of imparting surface hardness and suppressing surface defects, NiP plating is applied to the surface of the aluminum alloy substrate. Then, both principal planes of the aluminum alloy substrate on which a NiP plating film has been formed are subjected to a polishing process.

### PRIOR ART DOCUMENTS

### Patent Documents

Patent Document 1: Japanese Unexamined Patent Application, First Publication No. 2000-198064

Patent Document 2: Japanese Unexamined Patent Application, First Publication No. 2017-120680

### SUMMARY OF THE INVENTION

### Problems to be Solved by the Invention

Incidentally, when the Young's modulus of the aluminum alloy substrate is increased, additives such as Si, Mg, Cu and the like are contained in the alloy, and these are precipitated as simple substances or alloys at the grain boundaries. These precipitates are harder than aluminum serving as a base material. For this reason, the precipitates may fall off from the base material without being ground to form a recess, or if the precipitates remain on the processed surface, they may cause scratches as a result of machining. Therefore, in order to prevent occurrence of these precipitates, it is necessary to considerably slow down the processing speed, resulting in a decrease in the productivity of the grinding process, which was a problem.

The present invention has been proposed in view of such conventional circumstances, and has an object of providing a method of producing an aluminum alloy substrate for a magnetic recording medium, which makes it possible to produce an aluminum alloy substrate having high surface smoothness and less surface waviness with high productivity.

### Means for Solving the Problem

The present invention provides the following means.

(1) A method of producing an aluminum alloy substrate for a magnetic recording medium, which includes a step of subjecting both principal planes of a disk-shaped aluminum alloy substrate having a center hole to at least a grinding process, wherein

in the step of subjecting to the aforementioned grinding process, a grinding apparatus is used which includes: an upper platen and a lower platen as a pair that are opposed to each other; a carrier plate having one or more openings arranged on an opposing surface side of the aforementioned lower platen; and grinding pads attached respectively to the opposing surfaces of the aforementioned upper platen and the aforementioned lower platen,

wherein the aforementioned grinding pad has a structure in which a plurality of tile-shaped convex portions having a flat top portion are provided side by side and diamond abrasive grains are included in the convex portion and fixed in the aforementioned convex portion by a binder, an average particle diameter of the aforementioned diamond abrasive grains is from 2 to 15 μm, a content of diamond abrasive grains in the aforementioned convex portions is from 5 to 50% by volume, and in the step of subjecting to the aforementioned grinding process, both principal planes of the aforementioned aluminum alloy substrate are ground by the aforementioned grinding pad by disposing the aforementioned aluminum alloy substrate in an opening provided in the aforementioned carrier plate and relatively moving the aforementioned carrier plate in a plane with respect to the aforementioned upper platen and the aforementioned lower platen, while supplying a grinding fluid onto a surface of the aforementioned aluminum alloy substrate.

(2) The method of producing an aluminum alloy substrate for a magnetic recording medium according to the above (1), characterized in that in the aforementioned grinding pad, a diameter of a circumscribed circle in a plane at the top portion of the aforementioned convex portion is from 1.5 to 7 mm, a height of the aforementioned convex portion is from 0.1 to 5 mm, and an interval between the aforementioned convex portions that are adjacent to each other is from 0.4 to 5 mm.

(3) The method of producing an aluminum alloy substrate for a magnetic recording medium according to the above (1) or (2), characterized in that the aforementioned aluminum alloy substrate contains Si in a range of 3 to 30% by mass.

### Effects of the Invention

As described above, according to the present invention, it is possible to produce, with high productivity, an aluminum alloy substrate for a magnetic recording medium with high surface smoothness and less surface waviness.

### BRIEF DESCRIPTION OF THE DRAWINGS

FIG. 1 is a perspective view showing a preferable configuration example of a grinding apparatus used in a manufacturing process of an aluminum alloy substrate for a magnetic recording medium according to an embodiment of the present invention.

FIG. 2A is an enlarged plan view showing a main part of a grinding pad preferably used in the grinding apparatus shown in FIG. 1.

FIG. 2B is an enlarged cross-sectional view showing a main part of a grinding pad preferably used in the grinding apparatus shown in FIG. 1.

### DETAILED DESCRIPTION OF THE INVENTION

Hereinafter, preferred examples of a method of producing an aluminum alloy substrate for a magnetic recording medium to which the present invention is applied will be described in detail with reference to the drawings. However, the present invention is not limited only to the following examples and embodiments. Various changes in positions, numbers, sizes, quantities and the like can be made without departing from the spirit and scope of the present invention.

The aluminum alloy substrate for a magnetic recording medium produced by applying the present invention is a disk-like (doughnut disk-like) aluminum alloy substrate having a center hole. The magnetic recording medium is preferably configured by successively laminating a magnetic layer, a protective layer, a lubricating film and the like on the surface of the aluminum alloy substrate. In addition, in a magnetic recording/reproducing apparatus (HDD), the center portion of the magnetic recording medium is attached to a rotation axis of a spindle motor. Further, while a magnetic head floats and runs on the surface of the magnetic recording medium rotationally driven by the spindle motor, information is written to or read from the magnetic recording medium.

The aluminum alloy substrate for a magnetic recording medium is preferably produced by the following steps.

First, an aluminum alloy ingot is rolled to obtain an aluminum alloy sheet material having a thickness of about 2 mm or less. The obtained aluminum alloy sheet material is punched into a doughnut disk shape to obtain an aluminum alloy substrate having a desired size.

Next, chamfering of the inner and outer diameters and turning of both principal planes are performed on the punched aluminum alloy substrate. Thereafter, in order to reduce the surface roughness and waviness of the aluminum alloy substrate after the turning process, both principal planes of the aluminum alloy substrate are subjected to a grinding process with a grindstone.

Next, NiP plating is applied to the surface of the aluminum alloy substrate for the purpose of imparting surface hardness and suppressing surface defects. Thereafter, both principal planes of the aluminum alloy substrate on which the NiP plating film has been formed are subjected to a polishing process.

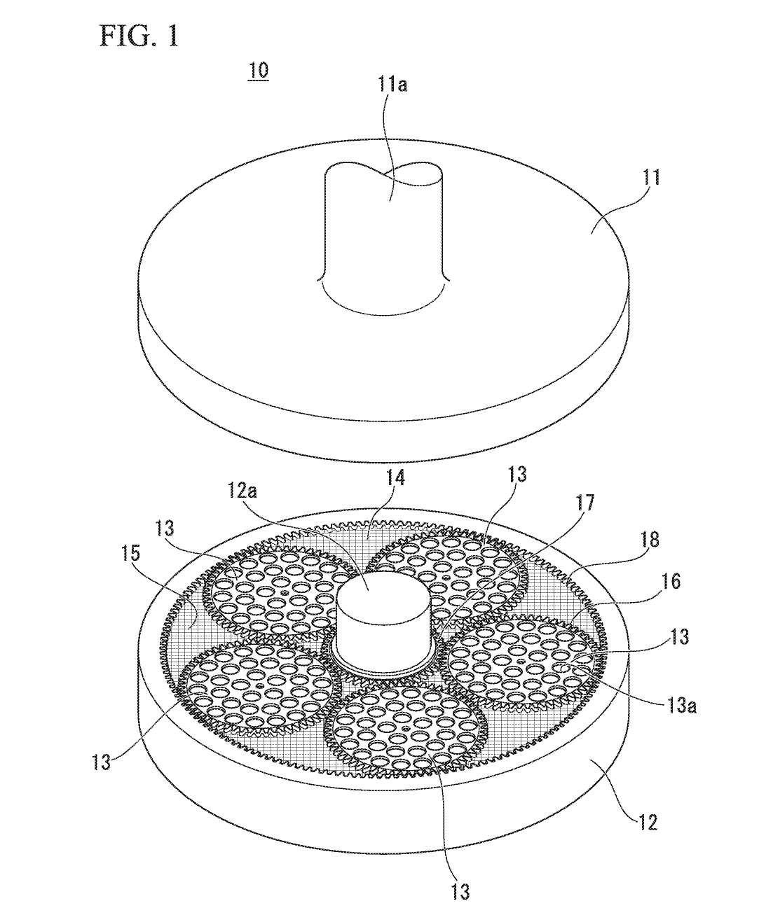

In the method of producing an aluminum alloy substrate for a magnetic recording medium to which the present invention is applied, for example, by using a grinding apparatus 10 as shown in FIG. 1, both principal planes of the aluminum alloy substrate (surfaces ultimately becoming the recording surfaces of the magnetic recording medium) are preferably subjected to a grinding process. It should be noted that FIG. 1 is a perspective view showing a configuration of the grinding apparatus 10.

As shown in FIG. 1, the grinding apparatus 10 of the present embodiment includes an upper platen 11 and a lower platen 12 forming a pair and facing each other, a plurality of carrier plates 13 having one or more openings and arranged on the opposing surface side of the lower platen 12, and grinding pads 14 that are attached to opposing surfaces of the upper platen 11 and the lower platen 12, respectively.

In the grinding apparatus 10, an aluminum alloy substrate can be arranged in each of a plurality of openings 13a provided in each carrier plate 13. Further, while supplying a grinding fluid onto the surface of the aluminum alloy substrate, both principal planes of the aluminum alloy substrate are ground with the grinding pad 14 by relatively moving the carrier plate 13 in the plane with respect to the upper platen 11 and the lower platen 12.

Rotation axes 11a and 12a which are provided at the respective center portions of the upper platen 11 and the lower platen 12 can rotationally drive the platens by a driving means (not shown) such as a drive motor. Accordingly, in a state in which their central axes are made to coincide with each other, the platens can be rotated in mutually opposite directions. In addition, on the opposing surface (upper surface) of the lower platen 12, a concave portion 15 (recessed portions) for arranging a plurality of carrier plates 13 is provided.

The plurality of carrier plates 13 may be disk shaped plates which are composed of an arbitrarily selected material, for example, an epoxy resin or the like which is reinforced by mixing an aramid fiber or a glass fiber. Further, these plurality of carrier plates 13 are arranged side by side around the rotation axis 12a inside the concave portion 15. In addition, a planetary gear 16 is provided throughout the entire circumference of the outer peripheral portion of each carrier plate 13. On the other hand, a sun gear 17 is provided at the inner peripheral portion of the concave portion 15 wherein the sun gear 17 can rotate together with the rotation axis 12a in a state of being engaged with the planetary gear 16 of each carrier plate 13. In addition, a fixed gear 18 that can be engaged with the planetary gear 16 of each carrier plate 13 is provided at the outer peripheral portion of the concave portion 15.

As a result, the plurality of carrier plates 13 undergo the so-called planetary motion. That is, when the sun gear 17 rotates together with the rotation axis 12a, the sun gear 17 and the fixed gear 18 are engaged with the planetary gear 16, so that, in the concave portion 15, the plurality of carrier plates 13 rotate about (rotation) their mutual central axes in the direction opposite to that of the rotation axis 12a while revolving around (revolution) the rotation axis 12a in the same direction as that of the rotation axis 12a.

There are no particular limitations on the means, method or configuration for supplying the grinding fluid as long as it can supply the grinding fluid to both principal planes of the aluminum alloy substrate. For example, one having a supply port which is provided on the upper platen 11 side and supplies the grinding fluid at a predetermined flow rate can be used.

The grinding fluid may be appropriately determined according to the material of the aluminum alloy substrate, the purpose of grinding, and the like. For example, a commercially available coolant or water can be used.

In the grinding apparatus 10 of the present embodiment having the above-described configuration, while causing a plurality of aluminum alloy substrates held in the openings 13a of the respective carrier plates 13 to undergo planetary motion, it is possible to grind both principal planes of the above-mentioned substrates by the grinding pads 14 provided on the upper platen 11 and the lower platen 12. In the case of this configuration, it is possible to perform the grinding process more accurately and quickly on a plurality of aluminum alloy substrates.

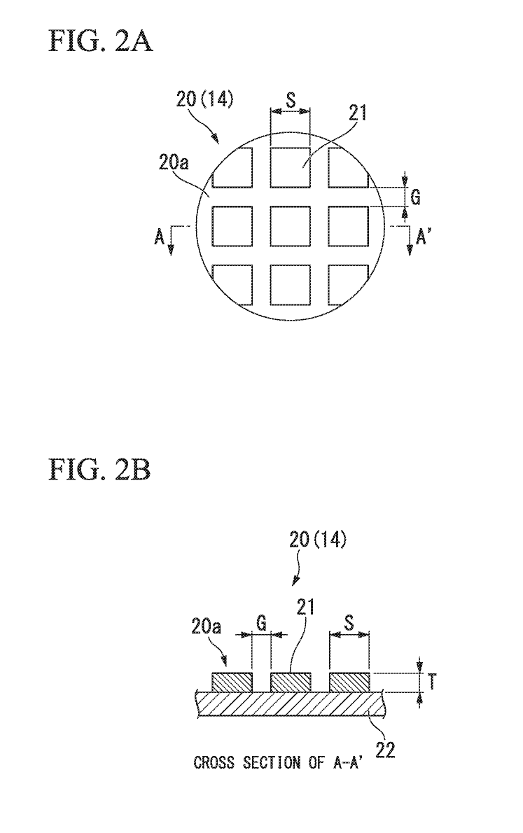

Incidentally, although the grinding pad 14 used in the grinding apparatus 10 of the present embodiment can be arbitrarily selected, for example, it is also preferable that the grinding pad 14 has a structure as shown in FIGS. 2A and 2B. It should be noted that FIG. 2A is an enlarged plan view showing a main part of the grinding pad 14. FIG. 2B is an enlarged cross-sectional view showing a main part of the grinding pad 14. Further, FIG. 2B shows a cross section of the grinding pad 14 taken along a line A-A′ shown in FIG. 2A.

As shown in FIGS. 2A and 2B, the grinding pad 14 of the present embodiment is preferably a diamond grindstone 20 in which diamond abrasive grains are fixed with a binder (bond). A grinding surface 20a of the grindstone has a plurality of tile-shaped convex portions (protruding portions) 21 which have a flat top portion and are provided side by side. Further, in the diamond grindstone 20, diamond abrasive grains are fixed with a binder in the convex portions 21 which are formed side by side on the surface of a base material 22. In this example, the convex portions are regularly arranged in a lattice shape. It should be noted that the binder of the diamond grindstone 20 can be arbitrarily selected, and for example, a resin such as a polyurethane-based resin, a phenol-based resin, a melamine-based resin, an acrylic resin, or the like can be used. Here, the flat top portion means that the convex portion (protruding portions) has a substantially flat surface, and the surface may have fine irregularities which is required for grinding.

Here, in the diamond grindstone 20 (grinding pad 14), the shape and arrangement of the convex portions 21 can be arbitrarily selected. For example, it is preferable that an outside dimension S of the convex portion 21 is 1.5 to 5 mm square. Alternatively, the diameter of a circumscribed circle (circle circumscribing the convex portion 21) in the plane at the top portion of the convex portion 21 is preferably in a range of 1.5 to 7 mm, and more preferably in a range of 3 to 5 mm.

Further, a height T of the convex portion 21 is preferably in a range of 0.1 to 5 mm, and more preferably in a range of 0.2 to 3 mm.

In addition, an interval G between the convex portions 21 that are adjacent to each other is preferably in a range of 0.4 to 5 mm, and more preferably in a range of 0.5 to 3 mm.

In the grinding apparatus 10 of the present embodiment, by using the diamond grindstone 20 (grinding pad 14) that satisfies the above ranges, the grinding fluid uniformly spreads through a groove. Therefore, workability is improved. Furthermore, it is possible to smoothly discharge ground chips and the like from between the convex portions 21 of the grinding surface 20a, and it is possible to prevent the machined surface of the substrate from being damaged by the hard ground chips composed of precipitates of Si, Mg, Cu or the like. The grooves formed between the convex portions 21 may form a grid or lattice pattern.

Further, the shape of the convex portion 21 is not limited only to the case where the grinding surface 20a has a square shape as shown in the FIG. 2A when the grinding surface 20a is viewed in plan. For example, the aforementioned surface may have a rectangular shape, a rhomboid shape, a polygonal shape, a circular shape, or the like. In this case, with respect to the size of the convex portion 21, the diameter of the circumscribed circle in the plane at the top portion of the convex portion 21 having the shape described above may be set within a range of 1.5 to 7 mm. Further, it is also preferable that the shape of the convex portion 21 is a columnar shape such as a quadrangular prism or truncated square pyramid.

In addition, in the diamond grindstone 20 (grinding pad 14), the average particle diameter of diamond abrasive grains can be arbitrarily selected, but it is preferably in a range of 2 to 15 μm, and more preferably in a range of 4 to 9 μm. Further, although the content of the diamond abrasive grains in the convex portion 21 can be arbitrarily selected, the content of the diamond abrasive grains is preferably in a range of 5 to 50% by volume, and more preferably in a range of 10 to 20% by volume. The content of the binder in the convex portion 21 can be arbitrarily selected. For example, the content of the binder in the convex portion 21 may be 5% by volume or more, 15% by volume or more, 30% by volume or more, 50% by volume or more, or 80% by volume or more. The content of the binder in the convex portion 21 may be 90% by volume or less, 80% by volume or less, 50% by volume or less, 40% by volume or less, or 20% by volume or less. The content of the binder may be 50 to 95% by volume, or 80 to 90% by volume. The convex portion 21 may include voids. The condition of the diamond abrasive grains in the convex portion 21 can be arbitrarily selected. For example, the diamond abrasive grains and the binder may be mixed uniformly. The diamond abrasive grains may be provided on the binder so that the diamond abrasive grains are fixed to a base material via the binder, or the diamond abrasive grains may be connected by the binder to each other and the grains may be bonded with a base material via the binder so that the grains do not separate from the base material.

When the particle diameter and content of the diamond abrasive grains fall below the above ranges, since the processing time is increased, the cost becomes high as a result. On the other hand, if the particle diameter and content of the diamond abrasive grains exceed the above ranges, it becomes difficult to obtain a desired level of surface roughness.

Then, for the purpose of imparting surface hardness and suppressing surface defects, NiP plating can be applied to the surface of the aluminum alloy substrate which has been subjected to the grinding process. As a method for forming a NiP-based plating film on the aluminum alloy substrate, for example, it is preferable to use an electroless plating method. The plating film composed of a NiP-based alloy can be formed by using a conventionally used method.

The thickness of the NiP-based plating film can be appropriately adjusted by the immersion time in the plating solution and the temperature of the plating solution. Plating conditions are not particularly limited, but it is preferable to set the pH of the plating solution to 5.0 to 8.6, the temperature of the plating solution to 70 to 100° C., preferably 85 to 95° C., and the immersion time in the plating solution to 90 to 150 minutes.

The obtained aluminum alloy substrate with the NiP-based plating film is preferably subjected to a heat treatment. This makes it possible to further increase the hardness of the NiP-based plating film and further increase the Young's modulus of the aluminum alloy substrate for a magnetic recording medium. The temperature of the heat treatment is preferably set to 300° C. or higher.

Both principal planes (surfaces ultimately becoming the recording surfaces of the magnetic recording medium) of the aluminum alloy substrate on which the NiP plating film has been formed are subjected to a polishing process. From the viewpoint of compatibility between improvement in surface quality, such as smoothness and less scratches, and improvement in productivity, for the polishing step, it is preferable to employ a multi-stage polishing system having two or more polishing processes using a plurality of independent polishing plates.

For example, it is preferable to carry out a rough polishing step of polishing while supplying a polishing liquid containing alumina abrasive grains by using a first polishing plate; and after washing the polished aluminum alloy substrate, a finish polishing step of polishing while supplying a polishing liquid containing colloidal silica abrasive grains using a second polishing plate. The polishing step can be carried out by a known method using a double-sided processing apparatus similar to the grinding step.

As described above, in the method of producing an aluminum alloy substrate for a magnetic recording medium to which the present invention is applied, by subjecting the aluminum alloy substrate to the grinding process using the above-described grinding apparatus 10, the grinding fluid uniformly spreads onto the grinding surface, and it becomes possible to smoothly discharge ground chips and the like from between the convex portions 21 of the grinding surface.

Therefore, according to the present invention, even in the case of grinding an aluminum alloy substrate having high Young's modulus and high rigidity which has conventionally been difficult to process, it is possible to produce an aluminum alloy substrate for a magnetic recording medium having high surface smoothness and little surface waviness with high productivity.

In particular, in the present invention, it is possible to subject the aluminum alloy substrate containing Si in a range of 3 to 30% by mass, more specifically, Si in a range of 5% by mass to 17% by mass, to a grinding process that brings about high surface smoothness with less surface waviness.

### EXAMPLES

Hereinafter, the effects of the present invention will be described more clearly by explaining using a series of examples. It should be noted that the present invention is not limited to the following examples, and can be carried out with appropriate modifications within the scope that does not change the spirit and gist of the present invention.

### Example 1

In Example 1, as a sheet material of an aluminum alloy, first, a product corresponding to A5086 (Mg: 4% by mass, Mn: 0.5% by mass, Fe: 0.3% by mass, Cr: 0.2% by mass, Si: 0.2% by mass, Zn: 0.2% by mass, balance: Al) was used. It should be noted that this sheet material was produced by obtaining an aluminum alloy ingot by a direct chill casting method and then rolling it. The thickness of the sheet material was 1.2 mm.

Next, the sheet material having a thickness of 1.2 mm was punched into a doughnut disk shape to obtain an aluminum alloy substrate having a center hole and a diameter of 97 mm. Thereafter, the sheet material was annealed at 380° C. for 1 hour. Then, cutting was performed for both principal planes and end surfaces of the aluminum alloy substrate with a diamond bit to obtain an aluminum alloy substrate having a diameter of 96 mm and a thickness of 0.8 mm.

Next, this aluminum alloy substrate was subjected to a grinding process by the method of the present invention. More specifically, a grinding apparatus having an upper platen, a lower platen and carrier plates was used such that plurality of aluminum alloy substrates were provided in openings of the respective carrier plates, and, while causing the aluminum alloy substrates held in the openings of the respective carrier plates to undergo planetary motion, both principal planes of the substrate were ground with grinding pads provided on the upper platen and the lower platen of the apparatus.

At this time, as a grinding pad, a diamond grindstone (product name: TRIZACT, manufactured by Sumitomo 3M Ltd.) was used. This diamond grindstone has convex portions (protruding portions), the outside dimension of the convex portion is 2.6 mm square, the height is 2 mm, the interval between adjacent convex portions is 1 mm, the average particle diameter of the diamond abrasive grains included in the convex portions is 6 μm, the content of diamond abrasive grains is about 15% by volume, and an acrylic resin is used as a binder.

Further, as the grinding apparatus, a 4-way type double-sided grinding machine (model 16B, manufactured by Hamai Co., Ltd.) was used. Then, by setting the rotational speed of the platen to 30 rpm and the processing pressure to 110 g/cm², grinding was carried out for 5 minutes. Water was used as a grinding fluid, and the amount of grinding per one side of the aluminum substrate was about 100 μm.

The obtained aluminum alloy substrate was immersed in a NiP-based plating solution, and a 88Ni-12P (P content: 12% by mass, balance: Ni) film was formed as a NiP-based plating film on the surface of the aluminum alloy substrate by using an electroless plating method.

As the NiP-based plating solution, a solution containing nickel sulfate (nickel source) and sodium hypophosphite (phosphorus source) was used, in which the amounts of components were adjusted by appropriately adding lead acetate, sodium citrate and sodium borate so as to obtain a NiP-based plating film having the above composition. The NiP-based plating solution at the time of forming the NiP-based plating film was adjusted to a pH of 6 and a liquid temperature of 90° C. The immersion time of the aluminum alloy substrate into the NiP-based plating solution was set to 2 hours.

Subsequently, the aluminum alloy substrate on which the NiP-based plating film was formed was heated at 300° C. for 3 minutes to obtain an aluminum alloy substrate with a NiP-based plating film.

Next, using a two-stage 4-way type double-sided polishing machine (model 11B, manufactured by System Seiko Co., Ltd.) equipped with a pair of upper and lower platens as a grinding polishing plate, the surface of the aluminum alloy substrate with the NiP-based plating film was polished to produce a disk-shaped aluminum substrate.

At this time, a suede type pad (manufactured by Filwel Co., Ltd.) was used as a polishing pad of the machine. Further, for the first stage polishing process, an aqueous solution which was adjusted to have a pH of 1.5 in an acidic region by adding alumina abrasive grains having D50 of 0.5 μm, a chelating agent and an oxidizing agent was used. In addition, for the second stage polishing process, an aqueous solution which was adjusted to have a pH of 1.5 in an acidic region by adding colloidal silica abrasive grains having D50 of 30 nm, a chelating agent and an oxidizing agent was used. Further, the polishing time was set to 5 minutes for each stage.

The processing pressure between the lower grindstone and the upper grindstone of the machine was set to 110 g/cm². The rotational speed of the lower grindstone and the upper grindstone was set to 20 rpm, the polishing amount in the first stage polishing process was set to about 1.5 μm, and the polishing amount in the second stage polishing process was set to about 0.5 μm.

For the produced aluminum alloy substrate for a magnetic recording medium of Example 1, evaluation tests regarding the surface waviness and smoothness were performed.

In the evaluation test for waviness, the amplitude of waviness within a wavelength range of 100 μm to 400 μm was measured using a non-contact surface shape measuring machine New View 5032 manufactured by Zygo Corporation. Further, in the evaluation test for smoothness, the center plane average roughness Ra in a region of 1 μm×1 μm was measured using an atomic force microscope (AFM), SPA 400 manufactured by SII NanoTechnology Inc.

In addition, the Young's modulus of the aluminum alloy was measured at room temperature according to Japanese Industrial Standard “JIS Z 2280-1993”. It should be noted that the Young's modulus was measured by cutting out the produced aluminum alloy substrate for a magnetic recording medium into a rectangular shape having a length of 50 mm, a width of 10 mm and a thickness of 0.8 mm, and using this as a test piece. The summarized results are shown in Table 1 below.

### Comparative Example 1

In Comparative Example 1, a grinding stone having silicon carbide abrasive grains having an average particle diameter of 4 μm was used as a grinding pad in a grinding process. The grinding stone used was a sponge-like grindstone in which silicon carbide abrasive grains were loaded with a polyvinyl alcohol resin or a phenol resin and pores of about 50% were formed with a pore forming agent (starch), and grooves for discharging chips are provided on the surface of the grindstone. The grinding stone does not have convex portions.

Other than that, an aluminum alloy substrate for a magnetic recording medium was produced in the same manner as in Example 1 described above. Further, evaluation tests regarding the surface waviness and smoothness and measurement of the Young's modulus were carried out on the produced aluminum alloy substrate for a magnetic recording medium of Comparative Example 1 in the same manner as in Example 1.

The summarized results are shown in Table 1 below.

### Examples 2 to 13

In Examples 2 to 13, the aluminum alloy substrate having the composition shown in the following Table 1 was subjected to a grinding process using the same diamond grinding stone as in Example 1. It should be noted that for production of an aluminum alloy substrate having a Si content of 23% or more, a powder metallurgy method was used instead of the direct chill casting method.

Other than that, an aluminum alloy substrate for a magnetic recording medium was produced in the same manner as in Example 1 described above. Further, evaluation tests regarding the surface waviness and smoothness and measurement of the Young's modulus were carried out on the produced aluminum alloy substrates for magnetic recording media of Examples 2 to 13 in the same manner as in Example 1. The summarized results are shown in Table 1 below.

### Comparative Examples 2 to 13

In Comparative Examples 2 to 13, the aluminum alloy substrate having the composition shown in the following Table 1 was subjected to a grinding process using the same grinding stone as in Comparative Example 1. It should be noted that for production of an aluminum alloy substrate having a Si content of 23% or more, a powder metallurgy method was used instead of the direct chill casting method.

Other than that, an aluminum alloy substrate for a magnetic recording medium was produced in the same manner as in Example 1 described above. Further, evaluation tests on the surface waviness and smoothness and measurement of the Young's modulus were carried out on the produced aluminum alloy substrates for magnetic recording media of Comparative Examples 2 to 13 in the same manner as in Example 1. The summarized results are shown in Table 1 below.

TABLE 1

| | | | Waviness | Ra | Young's |
|---|---|---|---|---|---|
| | Composition of aluminum substrate | Grindstone | (nm) | (nm) | modulus (GPa) |
| Ex. 1 | Al—4Mg—0.5Mn—0.3Fe—0.2Cr—0.2Si—0.2Zn | Diamond | 2.1 | 1.4 | 70 |
| Ex. 2 | Al—1Si—1.8Cu—0.01Sr | Diamond | 2.2 | 1.5 | 72 |
| Ex. 3 | Al—3Si—1.8Cu—0.01Sr | Diamond | 2.2 | 1.6 | 74 |
| Ex. 4 | Al—5Si—1.8Cu—0.01Sr | Diamond | 2.3 | 1.6 | 75 |
| Ex. 5 | Al—7Si—1.8Cu—0.01Sr | Diamond | 2.3 | 1.7 | 76 |
| Ex. 6 | Al—9Si—1.8Cu—0.01Sr | Diamond | 2.4 | 1.7 | 77 |
| Ex. 7 | Al—11Si—1.8Cu—0.01Sr | Diamond | 2.5 | 1.7 | 78 |
| Ex. 8 | Al—13Si—1.8Cu—0.01Sr | Diamond | 2.5 | 1.8 | 80 |
| Ex. 9 | Al—15Si—1.8Cu—0.01Sr | Diamond | 2.7 | 1.9 | 85 |
| Ex. 10 | Al—17Si—1.8Cu—0.01Sr | Diamond | 2.8 | 2.0 | 90 |
| Ex. 11 | Al—19Si—1.8Cu—0.01Sr | Diamond | 3.1 | 2.1 | 95 |
| Ex. 12 | Al—23Si—1.8Cu—0.01Sr | Diamond | 3.2 | 2.2 | 100 |
| Ex. 13 | Al—30Si—1.8Cu—0.01Sr | Diamond | 3.4 | 2.3 | 105 |
| Comp. Ex. 1 | Al—4Mg—0.5Mn—0.3Fe—0.2Cr—0.2Si—0.2Zn | SiC | 2.3 | 1.6 | 70 |
| Comp. Ex. 2 | Al—1Si—1.8Cu—0.01Sr | SiC | 2.7 | 2.3 | 72 |
| Comp. Ex. 3 | Al—3Si—1.8Cu—0.01Sr | SiC | 2.7 | 2.4 | 74 |
| Comp. Ex. 4 | Al—5Si—1.8Cu—0.01Sr | SiC | 2.8 | 2.5 | 75 |
| Comp. Ex. 5 | Al—7Si—1.8Cu—0.01Sr | SiC | 2.9 | 2.5 | 76 |
| Comp. Ex. 6 | Al—9Si—1.8Cu—0.01Sr | SiC | 3.1 | 2.6 | 77 |
| Comp. Ex. 7 | Al—11Si—1.8Cu—0.01Sr | SiC | 3.2 | 2.7 | 78 |
| Comp. Ex. 8 | Al—13Si—1.8Cu—0.01Sr | SiC | 3.4 | 2.9 | 80 |
| Comp. Ex. 9 | Al—15Si—1.8Cu—0.01Sr | SiC | 3.7 | 3.0 | 85 |
| Comp. Ex. 10 | Al—17Si—1.8Cu—0.01Sr | SiC | 3.8 | 3.0 | 90 |
| Comp. Ex. 11 | Al—19Si—1.8Cu—0.01Sr | SiC | 3.9 | 3.1 | 95 |
| Comp. Ex. 12 | Al—23Si—1.8Cu—0.01Sr | SiC | 4.2 | 3.3 | 100 |
| Comp. Ex. 13 | Al—30Si—1.8Cu—0.01Sr | SiC | 4.5 | 3.5 | 105 |

As shown in Table 1, it is clear that in the aluminum alloy substrates for magnetic recording media of Examples 1 to 13, as compared with the aluminum alloy substrates for magnetic recording media of Comparative Examples 1 to 13, the surface smoothness was high with less surface waviness. In addition, no concave portions or scratches having a depth of 2 μm or more were observed in the entire substrate.

The present invention can provide a method of producing an aluminum alloy substrate for a magnetic recording medium which makes it possible to produce an aluminum alloy substrate having high surface smoothness and less surface waviness with high productivity.

### DESCRIPTION OF THE REFERENCE SYMBOLS

10: Grinding apparatus
11: Upper platen
11a: Rotation axis of upper platen
12: Lower platen
12a: Rotation axis of lower platen
13: Carrier plate
13a: Opening
14: Grinding pad
15: Concave portion
16: Planetary gear
17: Sun gear
18: Fixed gear
20: Diamond grindstone
20a: Grinding surface
21: Convex portion
22: Base material
G: Interval between convex portions

1. A method of producing an aluminum alloy substrate for a magnetic recording medium, the method comprising:
a step of subjecting both principal planes of a disk-shaped aluminum alloy substrate having a center hole to at least a grinding process,
wherein in the step of subjecting to the grinding process,
a grinding apparatus is used which comprises:
an upper platen and a lower platen as a pair that are opposed to each other;
a carrier plate including one or more openings and arranged on an opposing surface side of the lower platen; and
grinding pads attached respectively to opposing surfaces of the upper platen and the lower platen,
the grinding pad has a structure in which a plurality of tile-shaped convex portions having a flat top portion are provided side by side, and diamond abrasive grains are included in the convex portion and fixed in the convex portion by a binder,
an average particle diameter of the diamond abrasive grains is from 2 to 15 μm,
a content of diamond abrasive grains in the convex portions is from 5 to 50% by volume, and
in the step of subjecting to the grinding process,
both principal planes of the aluminum alloy substrate are ground by the grinding pad by disposing the aluminum alloy substrate in an opening provided in the carrier plate and relatively moving the carrier plate in a plane with respect to the upper platen and the lower platen, while supplying a grinding fluid onto a surface of the aluminum alloy substrate.

2. The method of producing an aluminum alloy substrate for a magnetic recording medium according to claim 1,
wherein in the grinding pad, a diameter of a circumscribed circle in a plane at the top portion of the convex portion is from 1.5 to 7 mm,
a height of the convex portion is from 0.1 to 5 mm, and
an interval between the convex portions that are adjacent to each other is from 0.4 to 5 mm.

3. The method of producing an aluminum alloy substrate for a magnetic recording medium according to claim 1,
wherein the aluminum alloy substrate contains Si in a range of 3 to 30% by mass.
